(19) United States
(12) Patent Application Publication
(10) Pub. No.: US 2011/0050574 A1
(43) Pub. Date: Mar. 3, 2011

(54) KEYBOARD AND TILT ADJUSTMENT DEVICE THEREFORE

(76) Inventors: Dean Depay, San Jose, CA (US); Ray Gradwohl, Saratoga, CA (US); Jacques Gagne, Los Gatos, CA (US)

(21) Appl. No.: 12/546,832

(22) Filed: Aug. 25, 2009

(51) Int. Cl. G06F 3/02

(52) U.S. Cl. 345/168

(57) ABSTRACT

An embodiment of a keyboard has a tilt adjustment device that spans a width of the keyboard and that is pivotally attached to the keyboard. The tilt adjustment device is pivotable between a first position and a second position. When the tilt adjustment device is in the second position, the tilt adjustment device supports the keyboard in a second position that is tilted relative to a first position of the keyboard when tilt adjustment device is in the first position.

### BACKGROUND

Some keyboards, e.g., for desktop computers or the like, have adjustable tilt angles. Adjustable tilt angles enable a keyboard to be tilted at angles to fit a user's comfort level when operating the keyboard. For example, the tilt angle of some keyboards may be adjusted by moving individual tabs adjacent the upper edge of the keyboard from a first position, where the tabs are substantially flush with rear surface (e.g., the surface that faces a desktop, tabletop or other surface) of the keyboard, to a second position, where the tabs protrude from the rear surface of the keyboard. This sometimes involves a multi-step process of inverting the keyboard and moving each tab individually from the first to the second position or vice versa. Inverting the keyboard can interrupt work flow and may require repositioning the keyboard.

### DESCRIPTION OF THE DRAWINGS

FIG. 1 is a front perspective view of an embodiment of keyboard, according to an embodiment of the disclosure.

FIG. 2 is a right side view of an embodiment of keyboard with a tilt adjustment device in a first position, according to another embodiment of the disclosure.

FIG. 3 is a right side view of an embodiment of keyboard with a tilt adjustment device in a second position, according to another embodiment of the disclosure, the left side being a mirror image thereof.

FIG. 4 is an exploded perspective view of an embodiment of a tilt adjustment device, according to another embodiment of the disclosure.

FIG. 5 is a bottom view of an upper corner of an embodiment of keyboard, according to another embodiment of the disclosure.

FIGS. 6-8 are cutaway views of a portion of a right side of a keyboard respectively showing an embodiment of a tilt adjustment device at different positions, according to another embodiment of the disclosure.

### DETAILED DESCRIPTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that structural or mechanical changes may be made without departing from the scope of the claimed subject matter. The following detailed description is, therefore, not to be taken in a limiting sense, and the scope of the claimed subject matter is defined only by the appended claims and equivalents thereof.

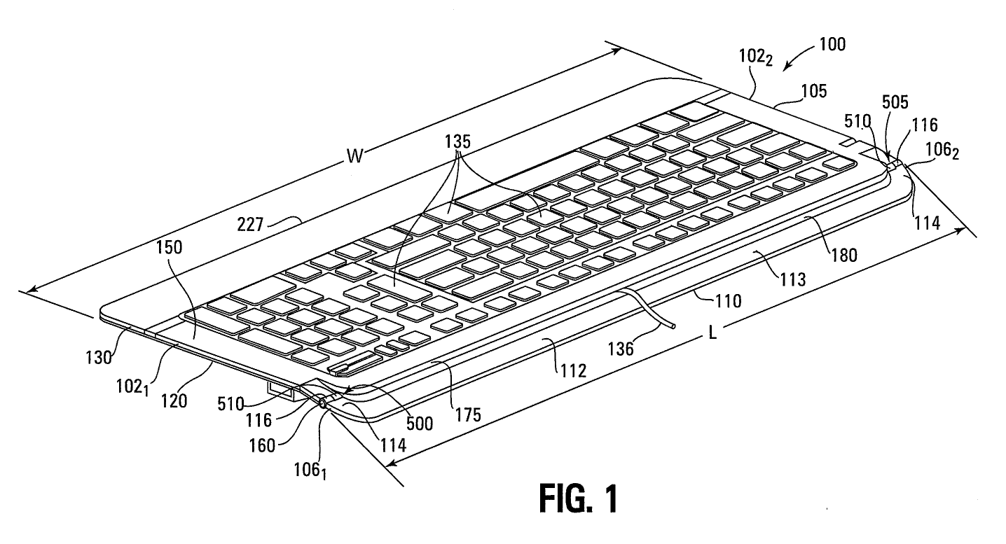

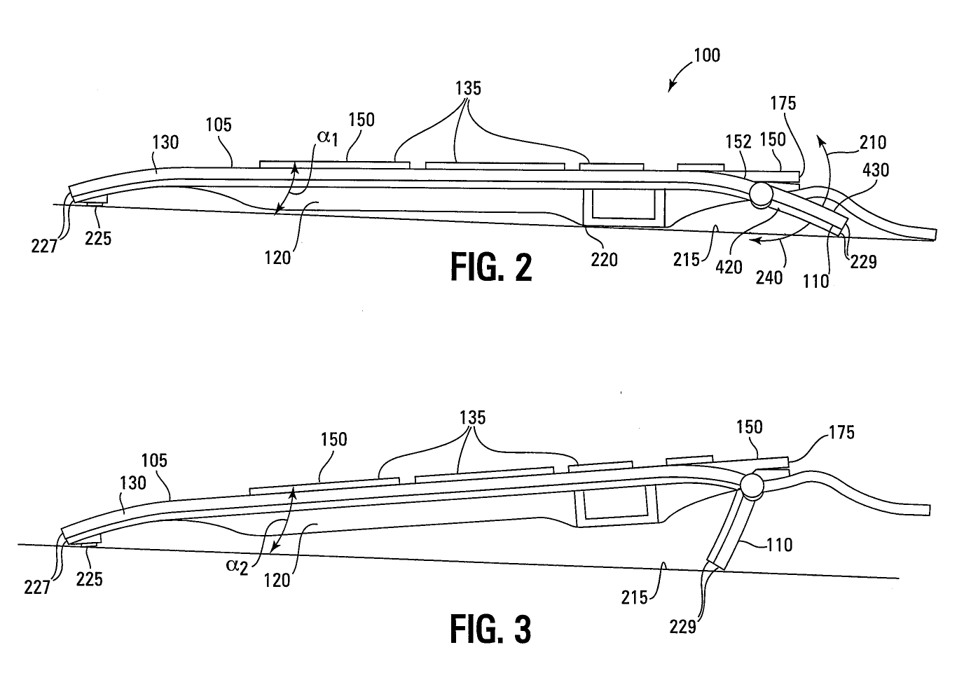

FIG. 1 is a front perspective view of a keyboard 100, e.g., a keyboard of a desktop computer, keyboard of a terminal for a mainframe computer, etc., according to an embodiment. Keyboard 100 includes a keyboard portion 105 and a tilt adjustment device (e.g., a tilt adjustment “foot”) 110 pivotally attached keyboard portion 105. Tilt adjustment foot 110 is pivotable between a first position shown in FIGS. 1 and 2 and a second position shown in FIG. 3. Note that the FIGS. 2 and 3 are right side views of keyboard 100 and that the left side of keyboard 100 may be a mirror image thereof.

Keyboard portion 105 has a rear panel 120 and a front panel 130 that may be attached to rear panel 120, e.g., by screws, snap fittings, or the like. Keys 135 are disposed in a recess in front panel 130 so that keys 135 protrude from the front of keyboard portion 105. A cord 136 electrically couples keyboard 100 to a computer or the like.

Tilt adjustment foot 110 spans an entire width W of keyboard portion 105, as shown in FIG. 1, and an overall length L of tilt adjustment foot 110 may be equal (e.g., substantially equal) to the width W of keyboard portion 105.

When tilt adjustment foot 110 is in its first position (FIGS. 1 and 2), tilt adjustment foot 110 may be prevented, by a suitable stop, from pivoting in the direction (indicted by arrow 210) opposite the direction in which tilt adjustment foot 110 pivots when pivoting from the first position to the second position (FIG. 3). When tilt adjustment foot 110 is in its first position, a portion of tilt adjustment foot 110 (e.g., a top edge 229 of tilt adjustment foot 110) may contact a surface 215, e.g., a desktop, tabletop, etc., on which keyboard portion 105 is placed concurrently with a portion 220 of a rear surface of rear panel 120 and concurrently with an optional stationary foot 225 adjacent a bottom edge 227 of keyboard portion 105. For example, tilt adjustment foot 110 may angle downward from a portion 150 of the front surface of keyboard portion 105 to surface 215, as shown in FIG. 2. The bottom edge 227 may also contact surface 215 when tilt adjustment foot 110 is in its first position. Note that the rear of the keyboard portion 105 faces surface 215 and faces opposite the front of keyboard portion 105 from which keys 135 protrude.

For one embodiment, when tilt adjustment foot 110 is in its first position and the top edge 229 thereof is contacting surface 215, a front surface 113 of tilt adjustment foot 110 forms a portion of the front of keyboard 100, as shown in FIG. 1. That is, front surface 113 extends the front surface of keyboard portion 105 when tilt adjustment foot 110 is in its first position. Moreover, when tilt adjustment foot 110 is in its first position, the contour of the right and left sides of tilt adjustment foot 110 may follow the contour of the right and left sides of keyboard portion 105, as shown for the right side in FIG. 2.

That is, the right and left sides of tilt adjustment foot 110 respectively extend the right and left sides of keyboard portion 105 and thus form portions of the right and left sides of keyboard 100 when tilt adjustment foot 110 is in its first position. For example, when tilt adjustment foot 110 is in its first position, the right side of keyboard portion 105 and tilt adjustment foot 110 form the right side of keyboard 100, and the left side of keyboard portion 105 and tilt adjustment foot 110 form the left side of keyboard 100.

For one embodiment, tilt adjustment foot 110 may angle downward from the portion 150 of the front surface of keyboard portion 105 by substantially the same angle as a portion 152 of keyboard portion 105 to surface 215 when tilt adjustment foot 110 is in its first position, as shown in FIG. 2. For example, a portion of the right and left sides of keyboard portion 105 may be inclined by the same inclination (e.g., substantially the same inclination) as the right and left sides of tilt adjustment foot 110 when tilt adjustment foot 110 is in its first position, as shown in FIG. 2.

For another embodiment, when in its first position, tilt adjustment foot 110 may maintain (e.g., support) keyboard portion 105 in the position of FIG. 2. For example, portion 220 of the rear surface of rear panel 120 may be supported above surface 215. Alternatively, when in its first position, tilt adjustment foot 110 may displaced above and out of contact with surface 215, with keyboard portion 105 being supported by stationary foot 225 and/or bottom edge 227 and portion 220 of the rear surface of rear panel 120.

When tilt adjustment foot 110 is in its first position, the upper surfaces of keys 135 may be inclined (e.g., tilted) at an angle (e.g., a tilt angle) α₁ relative to surface 215, where the angle α₁ is measured from the surface 215 to the upper surface of keys 135 (FIG. 2). This means that keyboard portion 105 may be inclined relative to surface 215 when tilt adjustment foot 110 is in its first position. For one embodiment, when tilt adjustment foot 110 is in its first position, tilt adjustment foot 110 may maintain keyboard portion 105 at the tilt angle α₁.

When tilt adjustment foot 110 is pivoted, e.g., in the direction of arrow 240, from its first position in FIG. 2 to its second position in FIG. 3, keyboard portion 105 is pivoted (e.g., tilted) relative to surface 215 about stationary foot 225 or about bottom edge 227 so that the inclination of the upper surfaces of keys 135 relative to surface 215 is increased relative to the inclination of the upper surfaces of keys 135 when tilt adjustment foot 110 is in its first position. That is, pivoting tilt adjustment foot 110 to its second position increases the tilt angle of keyboard portion 105 from tilt angle α₁ to tilt angle α₂, as shown in FIG. 3. This means that pivoting tilt adjustment foot 110 to its second position tilts keyboard portion 105 to a second position (FIG. 3) that is tilted (e.g. inclined) relative to a first position of keyboard portion 105 (FIG. 2) when tilt adjustment foot 110 is in its first position. Pivoting tilt adjustment foot 110 to its second position raises the top edge 175 so that top edge 175 is at a greater distance above surface 215 than top edge 175 is when tilt adjustment foot 110 is in its first position, as shown in FIGS. 2 and 3. When in its second position, tilt adjustment foot 110 maintains (e.g., supports) keyboard portion 105 at tilt angle α₂.

Note that the portion 150 of the front surface of keyboard portion 105 is parallel (e.g., substantially parallel) to the upper surfaces of keys 135, meaning that pivoting tilt adjustment foot 110 increases the inclination of portion 150 by the same amount as pivoting tilt adjustment foot 110 increases the tilt angle. Also note that tilt adjustment foot 110 can be pivoted as a single unit when keyboard portion 105 is in the upright position shown FIGS. 1-3, thereby eliminating the need to adjust individual leveling tabs individually and eliminating the need to invert keyboard portion 105 to adjust the pivot angle, e.g., by adjusting the individual leveling tabs.

Tilt adjustment foot 110 includes a bar 112 having a pair of extensions (e.g., tines) 114, e.g., that may extend substantially perpendicularly from opposite ends of bar 112, as shown in FIG. 1. A lug 116 may be formed at the end (e.g., tip) of each extension 114. Keyboard portion 105 is pivotally attached to extensions 114 adjacent top edge 175 of keyboard portion 105 so that an entire length of top edge 175 lies between extensions 114, as shown in FIG. 1, when tilt adjustment foot 110 is in its first position. When tilt adjustment foot 110 is in its first position, tilt adjustment foot 110 forms a portion of loop at the top of keyboard 100.

For example, extensions 114 may wrap around a portion of keyboard portion 105. That is, extensions 114 may wrap around upper corners 500 and 505 of keyboard portion 105, as shown in FIG. 1. There may be an opening 180 between a portion of keyboard portion 105 and a portion of tilt adjustment foot 110 when tilt adjustment foot 110 is in its first position. There may also be an opening between a rear portion of keyboard portion 105 and a portion of tilt adjustment foot 110 when tilt adjustment foot 110 is in its second position.

For one embodiment, bottom edge 227 terminates at and is connected to opposing side surfaces 102₁ and 102₂ of keyboard portion 105, as shown in FIG. 1, and the width W of keyboard portion 105 is the distance from side surface 102₁ to side surface 102₂. Extensions 114 of tilt adjustment foot 110 may also have opposing side surfaces 106₁ and 106₂ that form opposing sides of tilt adjustment foot 110, and the overall length L of tilt adjustment foot 110 is the distance from side surface 106₁ to side surface 106₂. For another embodiment, when overall length L of tilt adjustment foot 110 is equal (e.g., substantially equal) to the width W of keyboard portion 105, side surfaces 102₁ and 102₂ of keyboard portion 105 may be respectively flush (e.g., substantially flush) with side surfaces 106₁ and 106₂ of tilt adjustment foot 110. That is, side surfaces 102₁ and 102₂ of keyboard portion 105 may be respectively coplanar (e.g., substantially coplanar) with side surfaces 106₁ and 106₂ of tilt adjustment foot 110. Note that the contours of opposing side surfaces 106₁ and 106₂ of tilt adjustment foot 110 may respectively follow the contours of upper portions of opposing side surfaces 102₁ and 102₂ of keyboard portion 105 when tilt adjustment foot 110 is in its first position.

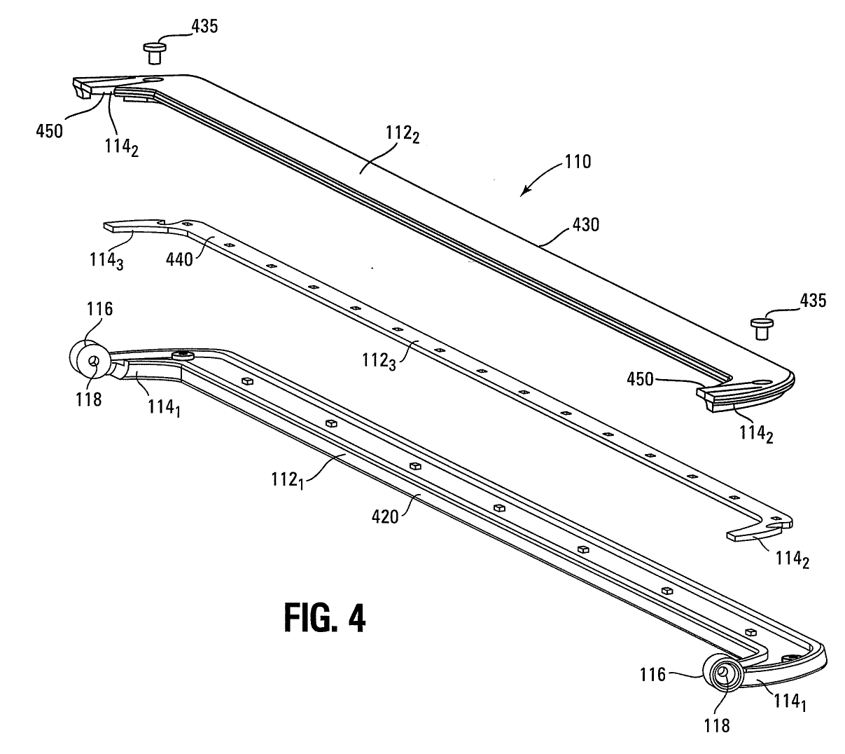

FIG. 4 is an exploded perspective view of tilt adjustment foot 110, according to another embodiment. For one embodiment, tilt adjustment foot 110 includes panels 420 and 430 that may be made of plastic, metal or the like. Panels 420 and 430 may be attached to each other using fasteners, such as screws 435. A stiffening panel 440, e.g., of metal, may be interposed between panels 420 and 430 for adding rigidity to tilt adjustment foot 110. Note that panel 420 and panel 430 may respectively correspond to rear panel 120 and front panel 130 of keyboard portion 105, as shown in FIG. 2. As such, panel 420 and panel 430 may respectively be referred to as rear panel 420 and front panel 430 of tilt adjustment foot 110. Therefore, when tilt adjustment foot 110 is in its first position, rear panel 120 and rear panel 420 form the rear of keyboard 100 and front panel 130 and front panel 430 form the front of keyboard 100, as shown in FIG. 2.

Panel 420, panel 430, and stiffening panel 440 may respectively include portions 112₁, 112₂, and 112₃ of bar 112 from which portions 114₁, 114₂, and 114₃ of extension 114 respectively extend perpendicularly (e.g., substantially perpendicularly) to portions 112₁, 112₂, and 112₃, as shown in FIG. 4. Bar portion 112₁ and extension portions 114₁ may be integrally formed, e.g., by molding. Similarly, bar portion 112₂ and extension portions 114₂ may be integrally formed, e.g., by molding. Bar portion 112₃ and extension portions 114₃ may be integrally formed, e.g., by stamping or molding.

For one embodiment, lugs 116 are attached to the tips of extension portions 114₁ of panel 420. A hole 118 is passed through each of lugs 116 for receiving a pin 160 therethrough (FIG. 1), where respective pins 160 pivotally attach tilt adjustment foot 110 to keyboard portion 105. Lugs 116 may be integrally formed, e.g., by molding, with portion 112₁ and extension portions 114₁. A resilient tab 450 may be formed, e.g., during molding, in each of extension portions 114₂ of panel 430, as shown in FIG. 4.

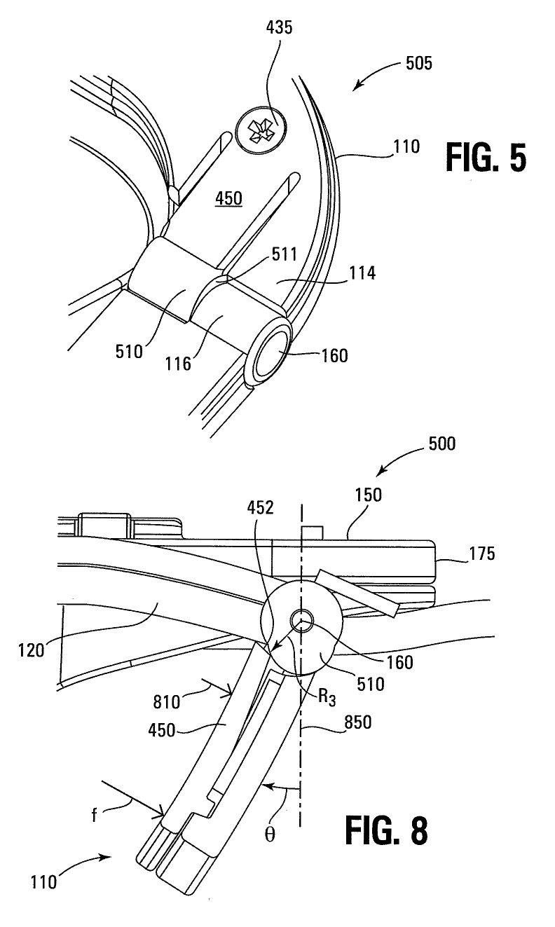

FIG. 5 is a bottom view of upper corner 505 (FIG. 1) of keyboard portion 105, with tilt adjustment foot 110 pivotally attached thereto. A bottom of upper corner 505 (FIG. 1) of keyboard portion 105 may be the same as that shown in FIG. 5. FIG. 5 shows tilt adjustment foot 110 in its first position and shows that resilient tab 450 engages a surface of a stationary cam 510 that is fixedly attached to keyboard portion 105. Note that there is a stationary cam 510 fixedly attached to keyboard portion 105 at opposite upper corners 500 and 505 of keyboard portion 105, as shown in FIG. 1.

Each cam 510 has a side surface 511 (FIG. 5) that may be parallel (e.g., substantially parallel) to a respective side surface 102 of keyboard portion 105. Lugs 116 of extensions 114 of tilt adjustment foot 110 may wrap around side surfaces 511 of cams 510, as shown in FIGS. 1 and 5, so that an inner side surface of each lug 116 faces and is parallel (e.g., substantially parallel) to a side surface 511 of a respective one of cams 510.

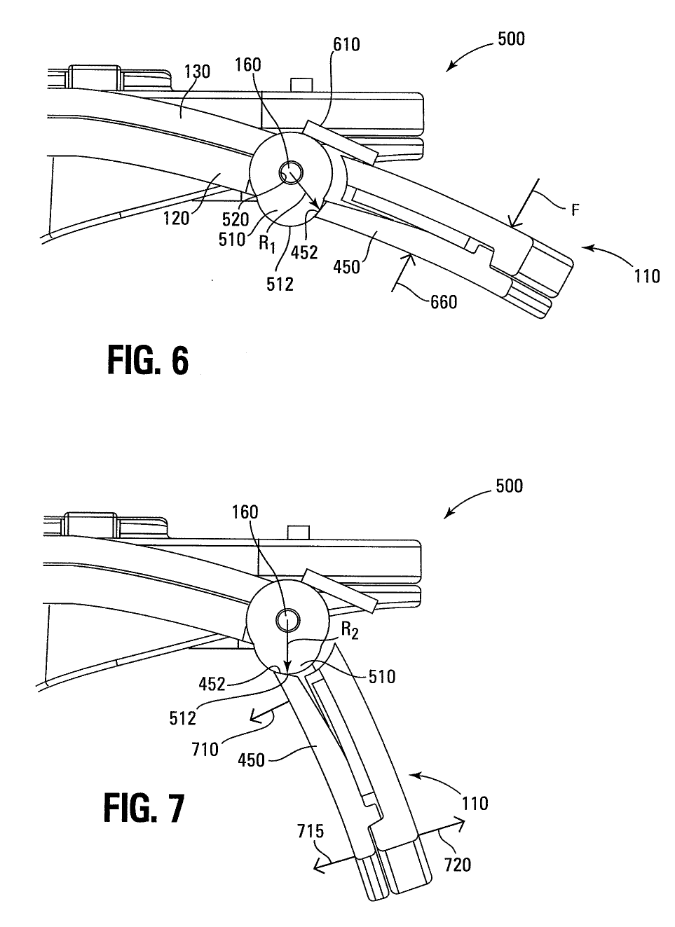

FIGS. 6-8 are cutaway views of the right side of keyboard 100 at corner 500 of keyboard 100 respectively showing tilt adjustment foot 110 at different positions. FIGS. 6 and 8 respectively show tilt adjustment foot 110 its first and second positions and respectively correspond to FIGS. 2 and 3. Note that FIGS. 6-8 illustrate the action of tilt adjustment foot 110 at either of corners 500 and 505 and that cutaway views of the left side of keyboard 100 at corner 505 may be mirror images of FIGS. 6-8.

Each cam 510 may be fixedly connected to front panel 130 of keyboard portion 105, as shown in FIG. 6. For example, cam 510 may be integrally formed with panel 130, e.g., by molding. A hole 520 passes through each cam 510 for receiving a pin 160. The hole 520 in each cam 520 is aligned with the hole 118 (FIG. 4) through a respective lug 116 (FIG. 5) and a pin 160 passes through the aligned holes 118 and 520. The top edge 175 of keyboard portion 105 may be located between cams 510, as shown in FIG. 1.

For one embodiment, a stop 610 may be fixedly attached to a portion of cam 510. When tilt adjustment foot 110 is its first position (FIGS. 2 and 6), tilt adjustment foot 110 abuts stop 610 and is thereby prevented by stop 610 from pivoting in the direction (indicated by arrow 210 in FIG. 2) opposite the direction in which tilt adjustment foot 110 pivots when pivoting from the first position to the second position (FIGS. 3 and 8). This enables tilt adjustment foot 110 to support at least a portion of the weight of keyboard portion 105, when tilt adjustment foot 110 is in its first position, by preventing tilt adjustment foot 110 from pivoting toward the front of keyboard portion 105 and away from surface 215 in the direction indicated by arrow 210.

When tilt adjustment foot 110 is in its first position, an end (e.g., tip) 452 of tab 450 may be biased into frictional contact with the surface of cam 510 by the resiliency of tab 450, as shown in FIG. 6. For example, tab 450 may resiliently engage cam 510 when tilt adjustment foot 110 is in its first position. Alternatively, tab 450 may be in a neutral position, with end 452 of tab 450 in frictional contact with the surface of cam 510, when tilt adjustment foot 110 is in its first position.

End 452 of tab 450 is at a nominal radius of R₁ from the center of pin 160 when tilt adjustment foot 110 is in its first position, as shown in FIG. 6, in that the portion of the surface of cam 510 in contact with end 452 is at the nominal radius of R₁. Note that the centers of pins 160 passing though the respective cams 510 are collinear and lie on the pivot axis about which tilt adjustment foot 110 pivots.

Tilt adjustment foot 110 is confined to pivot about the pivot axis at a fixed radius, and the eccentricity of the surface of cam 510 acts to prevent tilt adjustment foot 110 from pivoting from its first position in the absence of a user exerting an external force on tilt adjustment foot 110. This is because the radial distance from the surface of cam 510 to the center of pin 160 (the pivot axis) increases from the nominal radius of R₁, where end 452 of tab 450 contacts the surface of cam 510, to a location 512 on the cam surface, thereby preventing pivoting of adjustment foot 110 in the absence of a user exerting a force on tilt adjustment foot 110. As such, tilt adjustment foot 110 is biased in its first position.

To pivot tilt adjustment foot 110 toward the surface 215 (FIG. 2) from the first to second position, a user exerts an external force F on tilt adjustment foot 110. Tilt adjustment foot 110 pivots about the center of pin 160 at the fixed radius in response to the force F. As adjustment foot 110 pivots, the surface of cam 510 exerts a force on end 452 of tab 450 (in response to force F) that causes end 452 of tab 450 to move to nominal radius of R₂ from the center of pin 160 when adjustment foot 110 is at the intermediate position shown in FIG. 7. For example, the force exerted on end 452 of tab 450 acts to bend tab 450 away from tilt adjustment foot 110 in the direction of arrow 710, as shown in FIG. 7. As such, tab 450 resiliently engages cam 510 when tilt adjustment foot 110 is in its intermediate position.

The intermediate position corresponds to a toggle position, about which tilt adjustment foot 110 toggles. For example, an the instant when tilt adjustment foot 110 is moved past the intermediate position, e.g., in response to force F, in the direction of arrow 715, the resiliency of tab 450 exerts an internal force on cam 510 and on tilt adjustment foot 110 that pivots (e.g., “snaps”) tilt adjustment foot 110 to the second position shown in FIG. 8, without requiring any external force to be applied by the user to tilt adjustment foot 110. This is because the radial distance from the surface of cam 510 (location 512), and thus end 452 of tab 450, to the center of pin 160 decreases from the nominal radius of R₂, when tilt adjustment foot 110 at the intermediate position, to a nominal radius of R₃ from the center of pin 160 when tilt adjustment foot 110 is in the second position, as shown in FIG. 8. That is, as the radial distance from the surface of cam 510, and thus end 452 of tab 450, to the center of pin 160 decreases, the force exerted by the surface of cam 510 on end 452 decreases, causing tab 450 to relax and bend toward tilt adjustment foot 110 in the direction of arrow 810, as shown in FIG. 8. As such, tilt adjustment foot 110 is biased in its second position.

Note that when pivoting tilt adjustment foot 110 from the first position to the second position, the user needs to apply the force F to pivot tilt adjustment foot 110 to the intermediate position. At the instant tilt adjustment foot 110 moves past the intermediate position, the resiliency of tab 450 snaps tilt adjustment foot 110 to the second position, without requiring any force to applied by the user to tilt adjustment foot 110.

When tilt adjustment foot 110 is in its second position (FIG. 8) end 452 of tab 450 may be biased into frictional contact with the surface of cam 510 by the resiliency of tab 450 or may be in a neutral position, with end 452 in frictional contact with the surface of cam 510. For example, tab 450 may resiliently engage cam 510 when tilt adjustment foot 110 is in its second position.

When tilt adjustment foot 110 is in its second position, end 452 of tab 450 may abut rear panel 120 (FIG. 8), preventing further pivoting of tilt adjustment foot 110 in the direction of direction of arrow 715. This enables tilt adjustment foot 110 to support at least a portion of the weight of keyboard portion 105 when tilt adjustment foot 110 is in its second position by preventing tilt adjustment foot 110 from pivoting in the direction indicated by arrow 715.

At the instant when tilt adjustment foot 110 is moved past the intermediate position in the direction of arrow 720, the resiliency of tab 450 exerts an internal force on cam 510 and on tilt adjustment foot 110 that pivots (e.g., “snaps”) tilt adjustment foot 110 into the first position shown in FIG. 6, without requiring any external force to applied by the user to tilt adjustment foot 110. This is because the radial distance from the surface of cam 510 (location 512), and thus end 452 of tab 450, to the center of pin 160 decreases from the nominal radius of R₂, when tilt adjustment foot 110 at the intermediate position, to the nominal radius of R₁ from the center of pin 160 when tilt adjustment foot 110 is in the first position, as shown in FIG. 6. That is, as the radial distance from the surface of cam 510, and thus end 452 of tab 450, to the center of pin 160 decreases, the force exerted by the surface of cam 510 on end 452 decreases, causing tab 452 to relax and bend toward tilt adjustment foot 110 in the direction of arrow 660, as shown in FIG. 6.

To pivot tilt adjustment foot 110 from the second to first position, a user exerts an external force f on tilt adjustment foot 110. Tilt adjustment foot 110 pivots about the center of pin 160 at the fixed radius in response to the force f. As adjustment foot 110 pivots, the surface of cam 510 exerts a force on end 452 of tab 450 (in response to force f) that causes end 452 to move to nominal radius of R₂ from the center of pin 160 when adjustment foot 110 is at the intermediate position shown in FIG. 7. For example, the force exerted on end 452 of tab 450 acts to bend tab 450 away from tilt adjustment foot 110 in the direction of arrow 710, as shown in FIG. 7. At the instant when pivot tilt adjustment foot 110 moves past the intermediate position, e.g., in response to force f, the resiliency of tab 450 snaps pivot tilt adjustment foot 110 into the first position, without requiring any force to be applied by the user to tilt adjustment foot 110.

For one embodiment, when pivot tilt adjustment foot 110 is in its second position, pivot tilt adjustment foot 110 is at angled by an angle θ from a line 850 (in a direction toward the bottom edge 227 of keyboard portion 105) that passes through the center of pin 160 and that may be normal (perpendicular) to the portion 150 of the front surface of keyboard portion 105, and thus to the upper surfaces of keys 135 in that the portion 150 of the front surface of keyboard portion 105 may be parallel to the upper surfaces of keys 135. In other words, when pivot tilt adjustment foot 110 is in its second position, pivot tilt adjustment foot 110 is inclined toward bottom edge 227 of keyboard portion 105 (FIG. 3) in a direction away from when pivot tilt adjustment foot 110 is in its first position (FIG. 2).

### CONCLUSION

Although specific embodiments have been illustrated and described herein it is manifestly intended that the scope of the claimed subject matter be limited only by the following claims and equivalents thereof.

What is claimed is:

1. A keyboard, comprising:
a tilt adjustment device spanning a width of the keyboard and pivotally attached to the keyboard;
wherein the tilt adjustment device is pivotable between a first position and a second position; and
wherein when the tilt adjustment device is in the second position, the tilt adjustment device supports the keyboard in a second position that is tilted relative to a first position of the keyboard when tilt adjustment device is in the first position.

2. The keyboard of claim 1, wherein opposing side surfaces of the keyboard are respectively substantially flush with opposing sides of the tilt adjustment device.

3. The keyboard of claim 1, wherein the tilt adjustment device comprises at least one resilient tab that is configured engage a cam attached to the keyboard while the tilt adjustment device pivots between the first position and the second position.

4. The keyboard of claim 1, wherein the tilt adjustment device is biased in the first position when the tilt adjustment device is in the first position and the tilt adjustment device is biased in the second position when the tilt adjustment device is in the second position.

5. The keyboard of claim 1, wherein the tilt adjustment device is pivotable as a single unit.

6. The keyboard of claim 1, wherein when the keyboard is in the first position, the keyboard is tilted at a first angle with respect to a surface on which the keyboard is positioned and when the keyboard is in the second position, the keyboard is tilted at a second angle respect to the surface, the second angle being greater than the first angle.

7. The keyboard of claim 1, wherein when the tilt adjustment device is in the first position, a portion of the tilt adjustment device contacts a surface on which the keyboard is positioned.

8. The keyboard of claim 7, wherein when the tilt adjustment device is in the first position and the portion the tilt adjustment device contacts the surface on which the keyboard is positioned, the tilt adjustment device supports at least a portion of the weight of the keyboard.

9. The keyboard of claim 1, wherein the tilt adjustment device is configured to toggle between the first and second positions.

10. The keyboard of claim 1, wherein the tilt adjustment device forms a portion of a loop at the top of the keyboard when the tilt adjustment device is in the first position.

11. The keyboard of claim 1, wherein when tilt adjustment device is in the first position, a surface of the tilt adjustment device forms a portion of a front of the keyboard.

12. The keyboard of claim 1, wherein when tilt adjustment device is in the first position, sides of the tilt adjustment device follow a contour of sides of a portion of the keyboard that contains keys of the keyboard.

13. The keyboard of claim 1, wherein when tilt adjustment device is in the second position, tilt adjustment device is inclined away from the first position toward a bottom edge of the keyboard.

14. A keyboard, comprising:
a keyboard portion having a plurality of keys; and
a tilt adjustment foot having first and second extensions that respectively form portions of opposite sides of the tilt adjustment foot and that are pivotally attached to the keyboard portion;
wherein the tilt adjustment foot is pivotable as a single unit between a first position and a second position;
wherein tilt adjustment device spans an entire width of the keyboard portion and the first and second extensions of the tilt adjustment foot respectively wrap around opposite upper corners of the keyboard portion; and
wherein when the tilt adjustment device is in the first position, the keyboard portion is tilted at a first angle with respect to a surface on which the keyboard is positioned, and when the tilt adjustment device is in the second position, the keyboard portion is tilted at a second angle respect to the surface, the second angle being greater that the first angle.

15. The keyboard of claim 14, wherein when the tilt adjustment foot is in the first position, a portion of the tilt adjustment device and a stationary foot adjacent a bottom edge of the keyboard portion or the bottom edge of the keyboard portion concurrently contact the surface on which the keyboard is positioned.

16. The keyboard of claim 14, wherein there is an opening between a portion of the keyboard portion and a portion of the tilt adjustment foot when the tilt adjustment foot is in the first position.

17. The keyboard of claim 14, wherein when the tilt adjustment foot is in the second position, tilt adjustment foot is at angled away from a line that is normal to upper surfaces of the keys in a direction toward a bottom edge of the keyboard.

18. The keyboard of claim 14, wherein when tilt adjustment foot is in the first position, the opposite sides of the tilt adjustment foot are at an inclination that is substantially the same as an inclination of a portion of opposing sides of the keyboard portion.

19. A method of adjusting a tilt of a keyboard, comprising:
pivoting a tilt adjustment device as a single unit relative to the keyboard from a first position to a second position, the tilt adjustment device spanning an entire width of the keyboard;
wherein when the tilt adjustment device is in the second position, the tilt adjustment device supports the keyboard in a second position that is tilted relative to a first position of the keyboard when tilt adjustment device is in the first position.

20. The method of claim 19, further comprising pivoting the tilt adjustment device as a single unit relative to the keyboard from the second position back to the first position of the tilt adjustment device to return the keyboard to the first position of the keyboard.

21. The method of claim 19, wherein pivoting the tilt adjustment device as a single unit relative to the keyboard from the first position to the second position comprises pivoting the tilt adjustment device as a single unit while the keyboard is in an upright position on a surface that supports the keyboard.

22. The method of claim 19, wherein pivoting the tilt adjustment device as a single unit relative to the keyboard from the first position to the second position comprises:
a user applying an external force to the tilt adjustment device to pivot the tilt adjustment device from the first position to a third position between the first and second positions; and
a resilient tab of tilt adjustment device exerting an internal force on a cam of the keyboard and on the tilt adjustment device at an instant the tilt adjustment device moves past the third position that snaps tilt adjustment device into the second position without the user needing to apply the external force.
